(19) United States
(12) Patent Application Publication
(10) Pub. No.: US 2011/0135176 A1
(43) Pub. Date: Jun. 9, 2011

(54) System for Processing Medical Images Showing an Invasive Instrument

(75) Inventor: Markus Lendl, Ottensoos (DE)

(73) Assignee: SIEMENS MEDICAL SOLUTIONS USA, INC., Malvern, PA (US)

(21) Appl. No.: 12/853,395

(22) Filed: Aug. 10, 2010

Related U.S. Application Data
(60) Provisional application No. 61/266,526, filed on Dec. 4, 2009.

(51) Int. Cl. G06K 9/00

(52) U.S. Cl. 382/130

(57) ABSTRACT

A medical image data processing system automatically selects images showing an anatomically invasive instrument having a pair of instrument identification marker objects. An image data processor automatically, identifies one or more candidate image objects potentially representing invasive instrument marker objects in multiple images in a sequence of acquired images in response to predetermined size and shape data of marker objects. The image data processor identifies pairs of the identified candidate image objects potentially indicating an invasive instrument, in response to predetermined data associated with relative location of individual marker objects of a pair of identification marker objects of an invasive instrument. The image data processor selects in the multiple images, at least one of the identified pairs of identified candidate image objects in response to predetermined criteria and selects images of the multiple images associated with a selected pair of identified candidate image objects.

This is a non-provisional application of provisional application Ser. No. 61/266,526 filed 4 Dec., 2009, by Markus Lendl.

### FIELD OF THE INVENTION

This invention concerns a medical image data processing system for automatically selecting images showing an anatomically invasive instrument having a pair of instrument identification marker objects.

### BACKGROUND OF THE INVENTION

It is desirable to have precise and clear visibility of a stent in an angiographic image for evaluation of stent placement. A stent is used as an example of an object used invasively such as during a PTCA (Percutaneous Transluminal Coronary Angioplasty) procedure, for example. The location and inflation status of a stent are of particular interest. A stent comprises a mesh of fine wires (struts) and an X-ray based angiographic system is typically used for visualization of a stent during placement. Displaying stent struts is particularly challenging when a patient is large or X-ray beams are applied at steep angles. In order to improve image quality for stent imaging, multiple images may be registered (aligned) based on location of balloon marker balls on a stent and subsequently averaged. Correctly performed this procedure increases the CNR (Contrast to Noise Ratio) significantly and improves visibility of stent struts, or at least the limits of the stent. A pre-condition for a reasonable outcome of this image processing procedure is reliable selection of “consistent” and “sharp” image frames for further post-processing, like registration and averaging. In this context “consistent” means that the stent need to have the same shape in images used for post-processing. Image frames that include a stent with different curvature typically results in sup-optimal post-processing results. A “sharp” frame can be defined in terms of visibility of the marker ball borders and of course stent struts. Sharpness is degraded by motion blur. A blurred image decreases the quality of image post-processing results.

FIG. 1 shows three consecutive image frames 103, 105 and 107 of a moving vessel including a guide wire and an inflated stent. Image frames 103 and 107 display clearly defined balloon marker balls and a stent. Image frame 105 is distorted by motion blur and the upper marker ball is enlarged by the blur and the stent struts cannot be identified. A system according to invention principles addresses these problems and related problems.

### SUMMARY OF THE INVENTION

A system provides robust automated selection of specific medical image frames for further post-processing from an angiographic multi-frame image sequence that contains balloon markers using statistical analysis and application of multiple different criteria (e.g., marker velocity). A medical image data processing system automatically selects images showing an anatomically invasive instrument having a pair of instrument identification marker objects, for use in Angiography or another medical procedure. An image data processor automatically, identifies one or more candidate image objects potentially representing invasive instrument marker objects in multiple images in a sequence of acquired images in response to predetermined size and shape data of marker objects. The image data processor identifies pairs of the identified candidate image objects potentially indicating an invasive instrument, in response to predetermined data associated with relative location of individual marker objects of a pair of identification marker objects of an invasive instrument. The image data processor selects in the multiple images, at least one of the identified pairs of identified candidate image objects in response to predetermined criteria and selects images of the multiple images associated with a selected pair of identified candidate image objects.

### BRIEF DESCRIPTION OF THE DRAWING

FIG. 1 shows three consecutive image frames of a moving coronary vessel including a stent.

FIG. 2 shows a medical image data processing system that automatically selects images showing an anatomically invasive instrument having a pair of instrument identification marker objects, for use in Angiography or another medical procedure, according to invention principles.

FIG. 3 shows a flowchart of a process for selecting image frames out of a sequence of images for further post-processing including registration and averaging, according to invention principles.

FIG. 4 illustrates selection of image frames in a pre-determined ECG signal phase window for further evaluation, according to invention principles.

FIG. 5 shows an image presenting typical objects occurring in a cardiac angiographic image, according to invention principles.

FIG. 6 shows a flowchart of a process used by a medical image data processing system that automatically selects images, according to invention principles.

### DETAILED DESCRIPTION OF THE INVENTION

A system according to invention principles selects “consistent” and “sharp” images showing an anatomically invasive instrument having a pair of instrument identification marker objects. The system selects images for further post-processing (like registration and averaging) from a sequence of images by identifying “consistent” and “sharp” image frames. In the “consistent” and “sharp” image frames stents have substantially the same shape and marker balls and stent struts are substantially not degraded by motion blur. The system employs statistical marker pair selection based on multiple predetermined criteria concerning pre-classified marker-like objects in images. A marker sphere as used herein comprises a sphere or another radio-opaque object used to mark position or boundaries of a stent or invasive instrument.

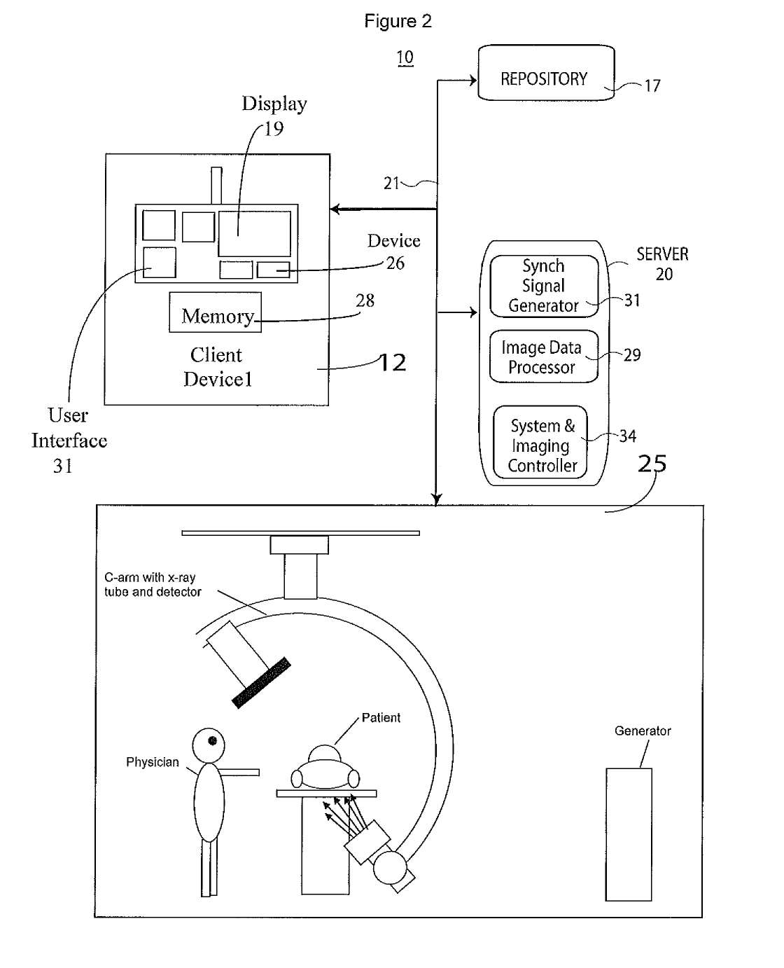

FIG. 2 shows a medical image data processing system 10 that automatically selects images showing an anatomically invasive instrument having a pair of instrument identification marker objects, for use in Angiography or another medical procedure. System 10 includes one or more processing devices (e.g., computers, workstations or portable devices such as notebooks, Personal Digital Assistants, phones) 12 that individually include memory 28, user interface 31, display 19 and a data entry device 26 such as a keyboard, mouse, touchscreen, voice data entry and interpretation device. System 10 also includes at least one repository 17, X-ray imaging modality system 25 (which in an alternative embodiment may comprise an MR (magnetic resonance), CT scan, or Ultra-sound system, for example) and server 20 intercommunicating via network 21. X-ray modality system 25 comprises a C-arm X-ray radiation source and detector device rotating about a patient table and an associated electrical generator for providing electrical power for the X-ray radiation system. The display images are generated in response to predetermined user (e.g., physician) specific preferences. At least one repository 17 stores medical image studies for multiple patients in DICOM compatible (or other) data format. A medical image study individually includes multiple image series of a patient anatomical portion which in turn individually include multiple images. At least one repository 17 also stores marker and other object data including data representing template marker objects having a predetermined size and shape and predetermined data and criteria concerning image objects and marker characteristics.

Server 20 includes image data processor 29 and system and imaging controller 34. User interface 31 generates data representing display images comprising a Graphical User Interface (GUI) for presentation on display 19 of processing device 12. Imaging controller 34 controls operation of imaging device 25 in response to user commands entered via data entry device 26. In alternative arrangements, one or more of the units in server 20 may be located in device 12 or in another device connected to network 21.

Image data processor 29 automatically identifies one or more candidate image objects potentially representing invasive instrument marker objects in multiple images in a sequence of acquired images in response to predetermined size and shape data of marker objects. Processor 29 identifies pairs of the identified candidate image objects potentially indicating an invasive instrument, in response to predetermined data associated with relative location of individual marker objects of a pair of identification marker objects of an invasive instrument. Processor 29 further selects in the multiple images, at least one of the identified pairs of identified candidate image objects in response to predetermined criteria and selects images of said plurality of images associated with a selected pair of identified candidate image objects.

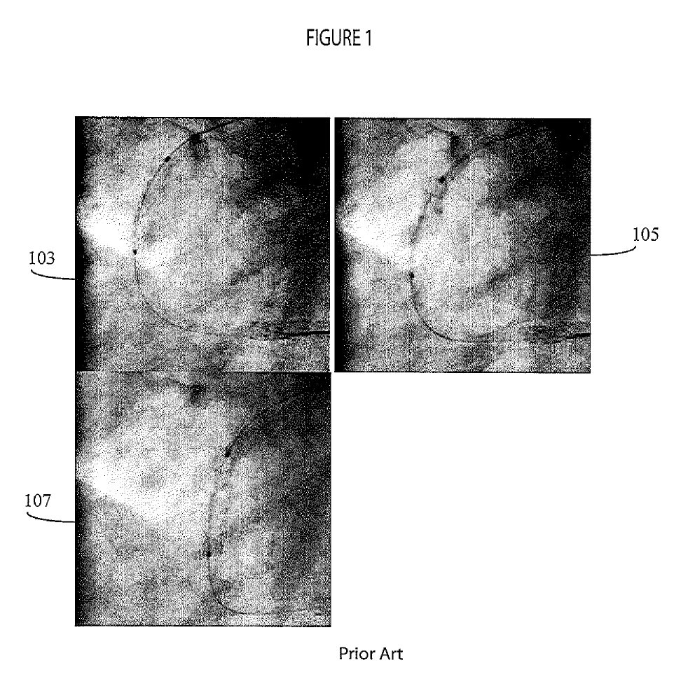

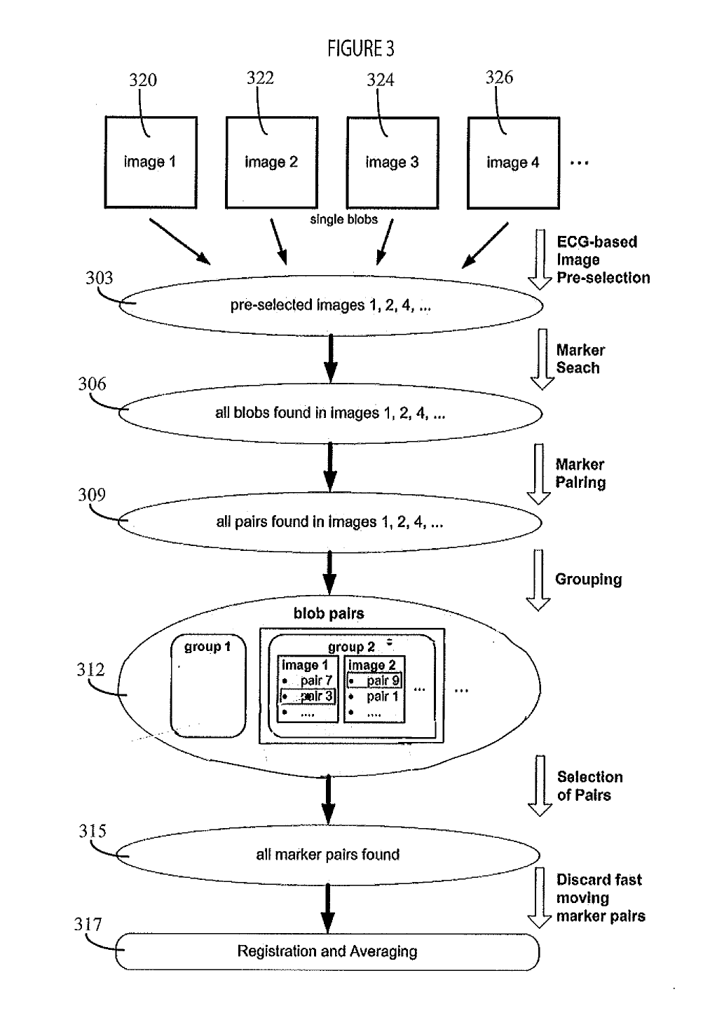

FIG. 3 shows a flowchart of a process employed by image data processor 29 for selecting image frames out of a sequence of images for further post-processing including registration and averaging. Processor 29 finds objects in the images that are generated by balloon markers and comprise marker-like dark spots in an image. The process of frame and object selection includes, ECG-based frame selection, Marker object search, Marker object pairing, Marker object grouping, Marker object pair selection and discarding of fast moving Marker object pairs. Processor 29 uses an ECG synchronization signal provided by ECG signal unit 31 (FIG. 1) to select images in step 303 from an image sequence (including images 320, 322, 324, 326) acquired by image acquisition device 25 in a “heart phase window” comprising a predetermined percentage of an R-R cycle (such as 50 to 85% of the cycle), for example. Processor 29 provides consistency since a stent has a repeatable imaged shape when the heart is in the same state, e.g. at the end-diastolic phase (complete expansion of the heart muscle).

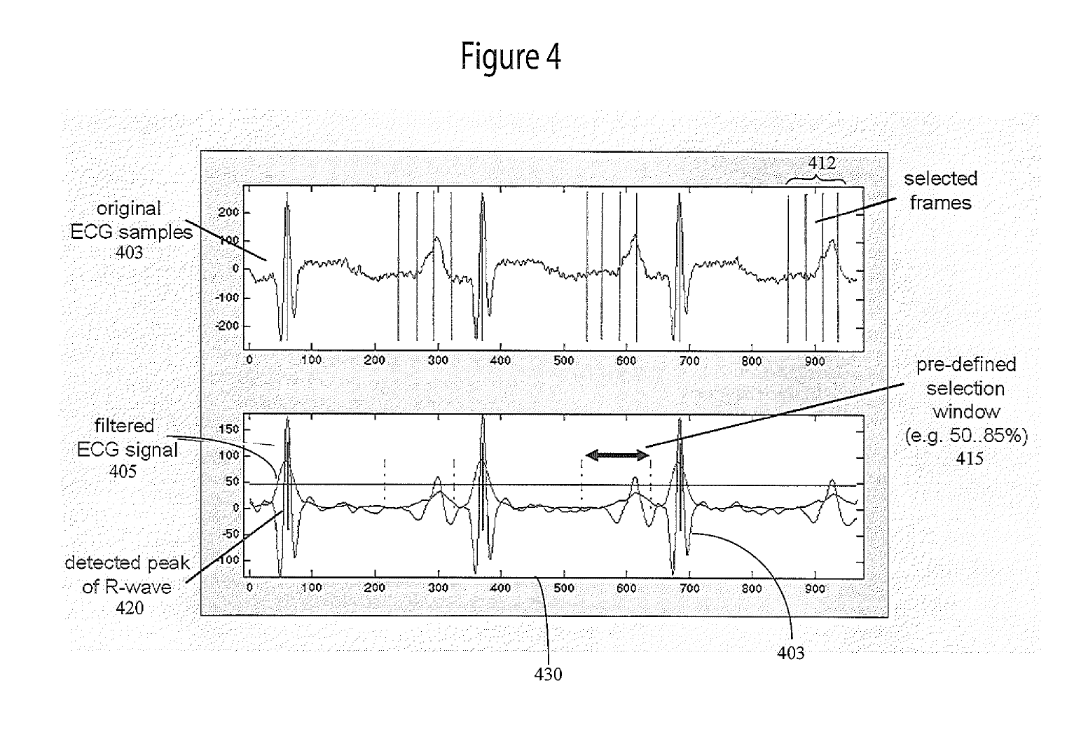

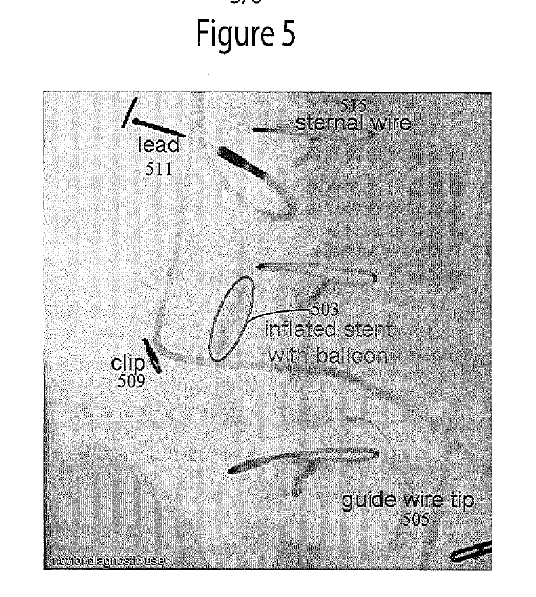

FIG. 4 illustrates selection of image frames in a pre-determined ECG signal phase window for further evaluation. Original ECG signal 403 is filtered by unit 31 (FIG. 1) to provide filtered ECG signal 405. Processor 29 triggers determination of a time window 415 from a detected R wave peak (as illustrated by peak 420) and selects images (e.g., the four images 412) in a predetermined time window e.g. 50-85% of an R-R cycle. Continuing with FIG. 3, in step 306 processor 29 performs a search for Marker-like objects in the selected images. Different known methods of marker search may be used including comparison and matching image objects with predetermined marker and object templates and by identifying luminance transitions indicating an object boundary and edge detection, for example and other known methods. Processor 29 searches individual images of the selected images for balloon marker-like objects. FIG. 5 shows an image presenting typical objects occurring in a cardiac angiographic image that are identified by processor 29. The typical objects include, an inflated stent balloon and marker object pair 503, guide wire tip 505, a clip 509, a lead 511 and sternal wire 515. Processor 29 determines the location of the two balloon markers in item 503 indicating the stent balloon. Processor 29 identifies desired objects and undesired marker-like objects.

In step 309 of FIG. 3 processor 29 identifies potential combinations of object pairs in individual images of the selected images that may comprise stent balloon marker objects. If less than two objects are detected in an image, the image is ignored. A candidate combination of object pairs is identified based on a length between objects falling in a predetermined range (e.g. between 20 and 150 pixels length) as indicated by data in repository 17. The system assumes stent balloons are considered to be within a specific length range depending on a clinical application and anatomical use, such as whether the use is for cardiac or peripheral applications, for example.

Processor 29, in step 312 identifies an image object pair as candidate stent balloon marker objects based on predetermined identification criteria stored in repository 17 and by considering objects clusters. The identification criteria includes, (a) an object pair occurs in multiple frames, (b) distance between objects does not change substantially between successive images e.g., objects are separated by a length within a predetermined range (e.g. +/−20 pixels), (c) balloon orientation as determined by a line connecting an object pair, does not change substantially, between successive images e.g., variation of direction of a line connecting an object pair is within a predetermined range (e.g. +/−10° and (d) movement of object pair location as determined by a mid point between the object pair, is limited between successive images e.g., an object pair mid point remains within a predetermined range (e.g. +/−50 pixels).

Processor 29, in step 315 selects image object pairs from the candidate pairs identified in step 312 by selecting a winning group (cluster) of pairs associated with different image frames, as having the highest number of pairs in a cluster. In selecting pairs, the system recognizes that a single object pair is a correct marker pair in a particular image. If there is more than one pair associated with the same image, the pair with the higher contrast (defined as a grey level difference between the object area and its background) is chosen. If multiple object pair groups have the same number of members, the system uses an average contrast value as a criterion to decide on which group wins, i.e., a group having the highest average contrast value is selected. Processor 29 in step 315 further selects images associated with a selected winning object pair in a selected winning group so that a single catheter and a single marker object pair present in the single image are selected. Thereby, if there is more than one marker object pair in a sequence of images, only one pair wins.

In step 317 processor 29 discards fast moving object pairs comprising image object pairs that move substantially between successive images in an image sequence and registers and averages multiple images in order to improve image quality for stent imaging. The multiple images are registered (aligned) based on the location of the identified balloon marker object pairs of a stent and the images are subsequently averaged. This procedure increases the CNR (Contrast to Noise Ratio) significantly and improves visibility of stent struts and limits of the stent. Processor 29 discards fast moving object pairs that are associated with transitional heart phases (contraction, expansion) to eliminate use of blurred object pairs in aligning different images which results in degraded image alignment. This improves image alignment for patients undergoing a PCTA (Percutaneous Transluminal Coronary Angioplasty) procedure that tend to exhibit arrhythmic heart beat cycles.

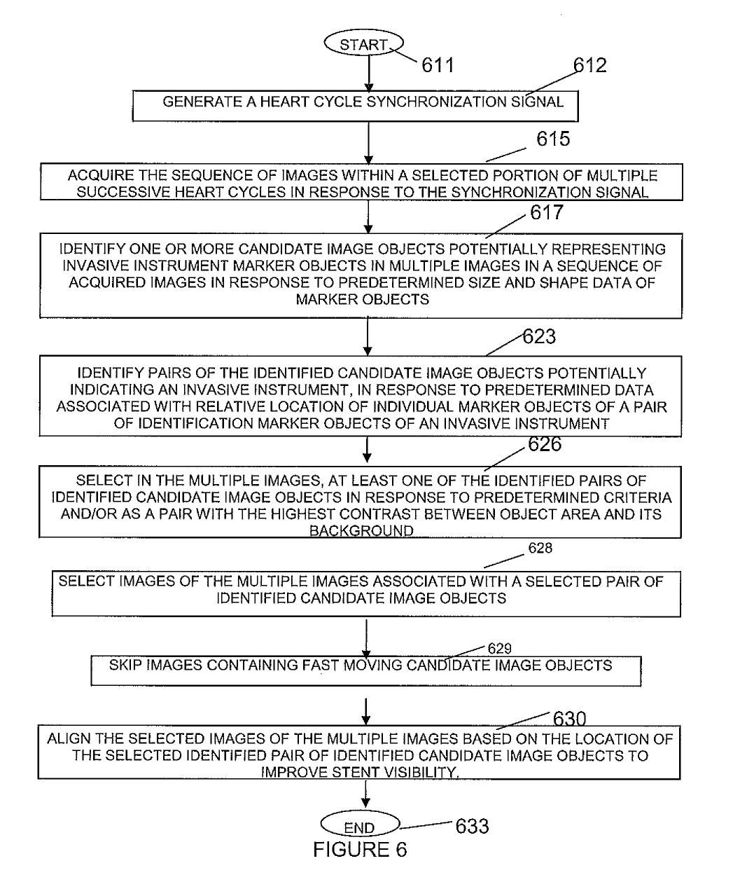

System 10 (FIG. 2) enhances robustness of image selection by using velocity information in an image selection process. This is accomplished using the information already provided. The system calculates a difference in location between an image object pair mid point occurring in a preceding and the succeeding image of an original image sequence. System 10 treats an image object pair as fast moving if a difference exceeds a predetermined value (e.g. 45 pixels @ 15 frames per second). In the absence of mid-point information for adjacent frames (e.g., because an image was masked by the ECG based frame selection method), system 10 uses a distance measure from an image object pair mid point to an averaged mid-point of an object group. Specifically, processor 29 calculates a particular mid-point location of an image object pair and measures the distance from this mid point to a mid-point comprising an average location for the group. System 10 selects images for post-processing with “consistent” and “sharp” stent image data. Consistency, is provided by using ECG-based frame pre-selection. System 10 discards images showing fast moving objects such as stents to improve sharpness to provide improved image quality after image registration and averaging, for example. FIG. 6 shows a flowchart of a process used by medical image data processing system 10 (FIG. 1) for automatically selecting images showing an anatomically invasive instrument having a pair of instrument identification marker objects, for use in Angiography or another medical procedure. In step 612 following the start at step 611, synchronization signal generator 31 generates a heart cycle synchronization signal. Image acquisition device 25 in step 615 acquires a sequence of images within a selected portion of multiple successive heart cycles in response to the synchronization signal (in a “dose saving mode”). Alternatively the system acquires images at a constant frame rate and selects images that are used for later processing e.g., within a selected heart cycle portion such as within the 50-85% portion of a heart cycle from an R wave, for example. In step 617, image data processor 29 automatically identifies one or more candidate image objects potentially representing invasive instrument marker objects in multiple images in the sequence of acquired images in response to predetermined size and shape data of template marker objects.

In step 623, image data processor 29 automatically identifies pairs of the identified candidate image objects potentially indicating an invasive instrument, in response to predetermined data associated with relative location of individual marker objects of a pair of identification marker objects of an invasive instrument in the multiple images. The image data processor excludes pairs of identified candidate image objects, from the identified pairs of identified candidate image objects, having a distance between the identified image objects outside of a predetermined range. Image data processor 29 identifies the pairs of the identified candidate image objects, in response to predetermined criteria and determining at least one of, (a) a distance between identified candidate image objects does not change substantially over the multiple images, (b) identified candidate image object orientation indicated by a projected line between a candidate pair of the identified candidate image objects does not change substantially over the multiple images and (c) movement of a candidate pair of the identified candidate image objects determined using at least a portion of the projected line does not change substantially over the multiple images. Image data processor 29 in step 626 automatically selects in the multiple images, at least one of the identified pairs of identified candidate image objects in response to predetermined criteria and/or as a pair with the highest contrast between object area and the object background.

In step 628, image data processor 29 automatically selects images of the multiple images associated with a selected pair of identified candidate image objects. Image data processor 29 excludes from use in image selection identified pairs of identified candidate image objects having a movement velocity between image frames exceeding a predetermined threshold velocity value. The image data processor also excludes from use in image selection, images having less than two identified candidate image objects. Image data processor 29 determines a movement velocity of an identified pair of identified candidate image objects between image frames by determining movement distance of substantially a mid-point of the pair of identified candidate image objects occurring between a successive pair of image frames.

Image data processor 29 identifies in the multiple images, at least one group of one or more of the identified pairs of identified candidate image objects in response to predetermined criteria; and selects images of the multiple images associated with an identified pair of identified candidate image objects in the at least one group. The image data processor identifies the group in response to the predetermined criteria indicating at least one of, (a) identified corresponding candidate image objects in the multiple images are within a predetermined threshold distance of each other, (b) the direction of a projected line joining an identified pair of identified candidate image objects in the multiple images is within a predetermined threshold angular range over the multiple images and (c) the median point of identified pairs of corresponding identified candidate image objects in the multiple images is within a predetermined threshold distance over the multiple images. Based on the velocity information image data processor 29 in step 629 excludes images images containing fast moving candidate image objects that may degrade the final resulting image. Image data processor 29 in step 630 aligns and averages the selected images of the multiple images based on the location of the selected identified pair of identified candidate image objects, to improve stent visibility. The process of FIG. 6 terminates at step 633. The resulting aligned and averaged image is displayed.

A processor as used herein is a computer, processing device, logic array or other device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a controller or microprocessor, for example, and is conditioned using executable instructions to perform special purpose functions not performed by a general purpose computer. A processor may be coupled (electrically and/or as comprising executable components) with any other processor enabling interaction and/or communication there-between. A display processor or generator is a known element comprising electronic circuitry or software or a combination of both for generating display images or portions thereof.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

The system and processes of FIGS. 2-6 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The system provides robust automated selection of specific medical image frames for alignment from an angiographic multi-frame image sequence that contains balloon markers using multiple different criteria (e.g., marker velocity, positional and orientation change). Further, the processes and applications may, in alternative embodiments, be located on one or more (e.g., distributed) processing devices on a network linking the units of FIG. 2, Any of the functions and steps provided in FIGS. 2-6 may be implemented in hardware, software or a combination of both.

What is claimed is:

1. A medical image data processing system for automatically selecting images showing an anatomically invasive instrument having a pair of instrument identification marker objects, for use in Angiography or another medical procedure, comprising:
an image data processor for automatically,
identifying one or more candidate image objects potentially representing invasive instrument marker objects in a plurality of images in a sequence of acquired images in response to predetermined size and shape data of marker objects;
identifying pairs of the identified candidate image objects potentially indicating an invasive instrument, in response to predetermined data associated with relative location of individual marker objects of a pair of identification marker objects of an invasive instrument in said plurality of images;
selecting in said plurality of images, at least one of the identified pairs of identified candidate image objects in response to predetermined criteria; and
selecting images of said plurality of images associated with a selected pair of identified candidate image objects.

2. A system according to claim 1, wherein
said image data processor selects in said plurality of images, said at least one of the identified pairs of identified candidate image objects as a pair with the highest contrast between object area and the object background.

3. A system according to claim 1, wherein
said image data processor aligns and averages the selected images of said plurality of images based on the location of the selected identified pairs of identified candidate image objects, to improve stent visibility.

4. A system according to claim 1, wherein
said image data processor identifies in said plurality of images, at least one group of one or more of the identified pairs of identified candidate image objects in response to predetermined criteria; and
selects images of said plurality of images associated with an identified pair of identified candidate image objects in said at least one group.

5. A system according to claim 4, wherein
said image data processor identifies said group in response to said predetermined criteria indicating at least one of, (a) identified corresponding candidate image objects in said plurality of images are within a predetermined threshold distance of each other, (b) the direction of a projected line joining an identified pair of identified candidate image objects in said plurality of images is within a predetermined threshold angular range over said plurality of images and (c) the median point of identified pairs of corresponding identified candidate image objects in said plurality of images is within a predetermined threshold distance over said plurality of images.

6. A system according to claim 1, wherein
said image data processor identifies one or more candidate image objects potentially representing invasive instrument marker objects in said plurality of images in response to a template marker object having a predetermined size and shape.

7. A system according to claim 1, wherein
said image data processor identifies said pairs of the identified candidate image objects, in response to said predetermined criteria determining at least one of, (a) a distance between identified candidate image objects does not change substantially over said plurality of images, (b) identified candidate image object orientation indicated by a projected line between a candidate pair of the identified candidate image objects does not change substantially over said plurality of images and (c) movement of a candidate pair of the identified candidate image objects determined using at least a portion of said projected line does not change substantially over said plurality of images.

8. A system according to claim 1, including
a synchronization signal generator for generating a heart cycle synchronization signal, and
an image acquisition device for acquiring the sequence of images within a selected portion of a plurality of successive heart cycles in response to said synchronization signal.

9. A system according to claim 1, wherein
said image data processor excludes from use in image selection identified pairs of identified candidate image objects having a movement velocity between image frames exceeding a predetermined threshold velocity value.

10. A system according to claim 9, wherein
said image data processor determines a movement velocity of an identified pair of identified candidate image objects between image frames by determining movement distance of a substantial mid-point of the pair of identified candidate image objects occurring between a successive pair of image frames.

11. A system according to claim 1, wherein
said image data processor excludes from use in image selection, images having less than two identified candidate image objects.

12. A system according to claim 1, wherein
said image data processor excludes pairs of identified candidate image objects, from the identified pairs of identified candidate image objects, having a distance between the identified image objects outside of a predetermined range.

13. A method employed by a medical image data processing system for automatically selecting images showing an anatomically invasive instrument having a pair of instrument identification marker objects, for use in Angiography or another medical procedure, comprising the activities of:
automatically,
identifying one or more candidate image objects potentially representing invasive instrument marker objects in a plurality of images in a sequence of acquired images in response to predetermined size and shape data of marker objects;
identifying pairs of the identified candidate image objects potentially indicating an invasive instrument, in response to predetermined data associated with relative location of individual marker objects of a pair of identification marker objects of an invasive instrument in said plurality of images;
selecting in said plurality of images, said at least one of the identified pairs of identified candidate image objects as a pair with the highest contrast between object area and the object background;
selecting images of said plurality of images associated with a selected pair of identified candidate image objects; and
aligning the selected images of said plurality of images based on the location of the selected identified pair of identified candidate image objects, to improve stent visibility.

14. A method according to claim 13, including the activity
selecting in said plurality of images, at least one of the identified pairs of identified candidate image objects in response to predetermined criteria.

15. A method according to claim 14, wherein
said image data processor identifies said pairs of the identified candidate image objects, in response to said predetermined criteria determining at least one of, (a) a distance between identified candidate image objects does not change substantially over said plurality of images, (b) identified candidate image object orientation indicated by a projected line between a candidate pair of the identified candidate image objects does not change substantially over said plurality of images and (c) movement of a candidate pair of the identified candidate image objects determined using at least a portion of said projected line does not change substantially over said plurality of images.

16. A medical image data processing system for automatically selecting images showing an anatomically invasive instrument having a pair of instrument identification marker objects, for use in Angiography or another medical procedure, comprising:
an image data processor for automatically,
identifying one or more candidate image objects potentially representing invasive instrument marker objects in a plurality of images in a sequence of acquired images in response to predetermined size and shape data of marker objects;
identifying pairs of the identified candidate image objects potentially indicating an invasive instrument, in response to predetermined data associated with relative location of individual marker objects of a pair of identification marker objects of an invasive instrument in said plurality of images;
identifying in said plurality of images, at least one group of one or more of the identified pairs of identified candidate image objects in response to predetermined criteria; and
selecting images of said plurality of images associated with a selected pair of identified candidate image objects in said at least one group.

17. A system according to claim 16, wherein
said image data processor identifies said pairs of the identified candidate image objects, in response to said predetermined criteria determining at least one of, (a) a distance between identified candidate image objects does not change substantially over said plurality of images, (b) identified candidate image object orientation indicated by a projected line between a candidate pair of the identified candidate image objects does not change substantially over said plurality of images and (c) movement of a candidate pair of the identified candidate image objects determined using at least a portion of said projected line does not change substantially over said plurality of images.

18. A system according to claim 16, wherein
said image data processor selects in said plurality of images, said at least one of the identified pairs of identified candidate image objects as a pair with the highest contrast between object area and the object background.

19. A system according to claim 16, wherein
said image data processor aligns the selected images of said plurality of images based on the location of the selected identified pairs of identified candidate image objects, to improve stent visibility.
